(19) United States
(12) Patent Application Publication
(10) Pub. No.: US 2014/0094277 A1
(43) Pub. Date: Apr. 3, 2014

(54) MANAGING GIFTING BETWEEN PLAYERS IN A GAMING ENVIRONMENT

(71) Applicant: WMS GAMING, INC., Waukegan, IL (US)

(72) Inventors: Andrew Christian Guinn, Chicago, IL (US); Richard B. Robbins, Glenview, IL (US); Jamie W. Vann, Chicago, IL (US); Brian J. Barclay, Atlanta, GA (US)

(73) Assignee: WMS GAMING, INC., Waukegan, IL (US)

(21) Appl. No.: 13/784,919

(22) Filed: Mar. 5, 2013

Related U.S. Application Data
(60) Provisional application No. 61/706,937, filed on Sep. 28, 2012.

(51) Int. Cl. G07F 17/32

(52) U.S. Cl. CPC G07F 17/3281
USPC 463/25

(57) ABSTRACT

Gifting in a gaming environment may be managed by determining a transfer of a gift value from a first player account to a second player account and determining a wager of the gift value from the second player account in a wagering game. A gift win amount attributable to a winning outcome of the wagering game when the gift value is used may be determined, and respective shares of the gift win amount may be allocated to the first and second player accounts.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present disclosure relates generally to gaming apparatus and methods and, more particularly, to systems and methods for managing gifting between players in a gaming environment.

### BACKGROUND OF THE DISCLOSURE

Wagering game machines, such as slot machines, video poker machines, and the like, have been a cornerstone of the gaming industry for several years. Traditionally, wagering game machines have been confined to physical structures, such as land- or water-based casinos (e.g., resort casinos, road-side casinos, casino boats, etc.). Casinos are located in specific geographical locations that are authorized to present wagering games to casino patrons. The proliferation of interest and use of a global public network (such as the Internet), however, potentially expands access to wagering games to locations outside of the physical casino structures. Consequently, any individual with a personal computing device (e.g., a personal computer, a laptop, a personal digital assistant, a mobile phone, etc.) can connect to the Internet and process wagering games. Consequently, some wagering game manufacturers have created wagering games that can be processed by personal computing devices and offered via online casino websites (“online casinos”). Several challenges, however, confront the development and operation of online casinos. For example, online casinos have struggled to provide the excitement and entertainment found in real world casino environments. Some online casinos have found it difficult to enforce cross-jurisdictional restrictions and requirements. Further, some online casinos have struggled to adapt the online gaming industry to a traditionally non-wagering game business environment. Consequently, wagering game manufacturers, casino operators, and online game providers are confronted with various challenges to making the online gaming industry appealing and profitable.

### SUMMARY OF THE DISCLOSURE

According to one aspect of the disclosure, a computer-implemented method of managing gifting in a wagering game may include determining a transfer of a gift value from a first player account to a second player account; determining a wager of the gift value from the second player account in the wagering game; determining a gift win amount attributable to an outcome of the wagering game when the gift value is used; determining a first player portion of the gift win amount; and determining a second player portion of the gift win amount.

According to another aspect of the disclosure, a gaming system includes a processor, a memory in communication with the processor, a display, and an input/output circuit, where the processor is physically configured according to computer executable instructions for managing gifting in a wagering game. The computer executable instructions may include instructions for determining a transfer of a gift value from a first player account to a second player account; determining a wager of the gift value from the second player account in the wagering game; determining a gift win amount attributable to an outcome of the wagering game when the gift value is used; determining a first player portion of the gift win amount; and determining a second player portion of the gift win amount.

According to yet another aspect of the present disclosure, a tangible machine-readable storage media includes instructions which, when executed by one or more processors, cause the one or more processors to perform the above methods.

Additional aspects will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a schematic illustration of a gaming system according to an embodiment of the present disclosure.

FIG. 2 is a schematic illustration of an online gaming server usable in the gaming system of FIG. 1.

FIG. 3 is a schematic illustration of a computational device usable in the gaming system of FIG. 1.

FIG. 4a is a perspective view of a free-standing gaming machine usable in the gaming system of FIG. 1.

FIG. 4b is a schematic illustration of architecture for the gaming machine of FIG. 4a.

FIG. 5 is a perspective view of a mobile gaming machine usable in the gaming system of FIG. 1.

FIG. 6a is an image of an exemplary registration interface for a gaming service displayed on an output device of a client, according to an embodiment of the present disclosure.

FIG. 6b is an image of an exemplary gameplay interface for a gaming service displayed on an output device of a client, according to an embodiment of the present disclosure.

FIG. 7 is an illustration of a manner of managing gifting in a gaming environment.

FIG. 8 is an illustration of an embodiment of managing gifting in a gaming environment using a gift currency.

While the claimed subject matter is susceptible to various modifications and alternative forms, specific embodiments have been shown by way of example in the drawings and will be described in detail herein. It should be understood, however, that the claimed subject matter is not intended to be limited to the particular forms disclosed. Rather, the intention is to cover all modifications, equivalents, and alternatives falling within the spirit and scope of the appended claims.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts. While the present disclosure may be embodied in many different forms, the embodiments set forth in the present disclosure are to be considered as exemplifications of the principles of the present disclosure and are not intended to be limited to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino game formats. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

### Overall Network

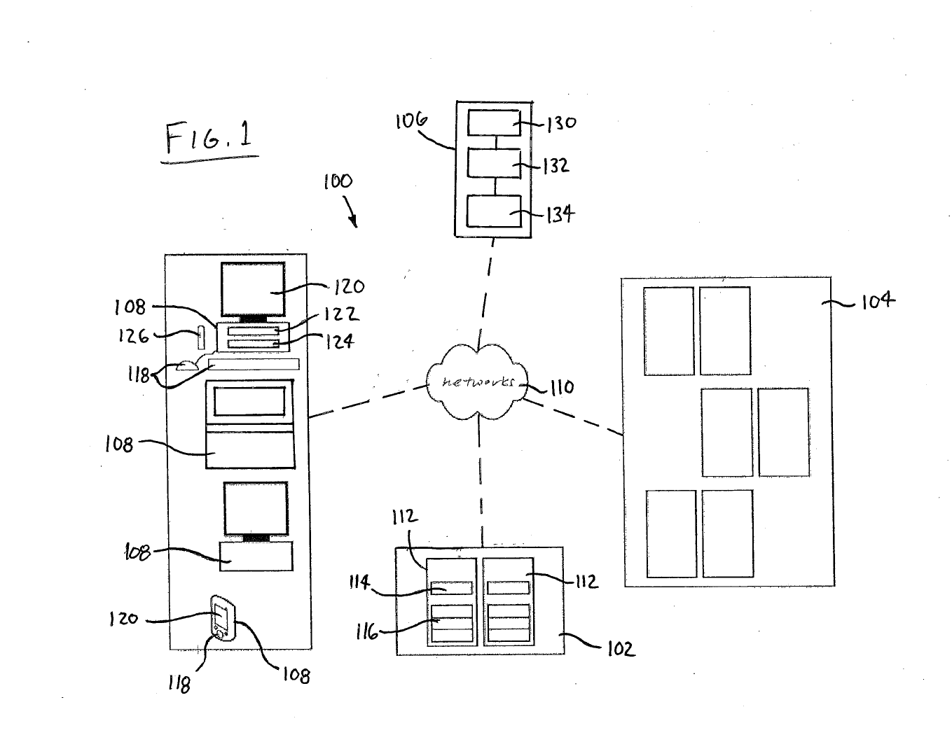

Referring to FIG. 1, one exemplary embodiment of a gaming system 100 is provided. In general, the gaming system 100 may be used to manage and/or facilitate certain interactions between gaming service providers, players or registrants of games provided by the gaming service providers, as well as social and/or virtual communities with which the players or registrants may be affiliated, associated and/or registered. As shown, the gaming system 100 includes at least one or more gaming servers 102, one or more community servers 104, one or more account servers 106, and one or more client devices 108, as well as one or more networks 110 electronically communicating information between each of the gaming servers 102, community servers 104, account servers 106, and clients 108. More specifically, the one or more networks 110 enable users or registrants at the client devices 108 to access gaming services from the gaming servers 102, social networks and/or virtual communities from the community servers 104, and account services from the account servers 106.

While each component of the gaming system 100 is shown as a separate and distinct element connected via a communications network 110, some of functions discussed herein as being performed by one component may be performed by other components. For example, the gaming servers 102 may also be configured to gather and store biometric data, record and store online gaming activity, transfer shared files between player accounts, etc. The components shown may all be contained in one device, but some, or all, may be included in, or performed by multiple devices, or other configurations not shown.

Furthermore, the gaming system 100 may be implemented as software, hardware, any combination thereof, or other forms not listed. For example, any of the network components (e.g., the gaming servers 102, community servers 104, account servers 106, client devices 108, etc.) may include hardware and machine-readable media including instructions for performing the operations described herein. Machine-readable media includes any mechanism that provides (i.e., stores and/or transmits) information in a form readable by a machine (e.g., a gaming machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

Thus, in some embodiments, the clients 108 may be dedicated gaming devices such as a gaming device provided in a casino. The gaming device may execute the gaming computer code locally or the gaming device may be thought of as a node on a network where one or more servers (which may be local or remote) may execute code and the video signal may be communicated to the gaming device. In other embodiments, the gaming device may be a computing device in a user's home such as a personal computer. The processor in the computing device may be physically configured to execute the code on the personal computer. In other embodiments, the computing device may be thought of as a node on a network where a server is physically configured according to the gaming computing instructions. In yet another embodiment, the gaming device may be a portable computing device. The portable computing device may be physically configured to execute the gaming code or the portable computing device may be in communication with a server that executes some or all of the gaming code and communicates images to be displayed. In all the embodiments, the gaming device may communicate with a central authority that may track game play, awards, likes, dislikes, etc., assuming sufficient permission is obtained. The communication may be wired or wireless and the communication may be secured in a manner to ensure the integrity of the game and the privacy of the player information. In addition, the game may operate on a variety of platforms, from an operating system on a PC to a social media application on a portable computing device platform, to a gaming console platform.

### Gaming Servers

As shown in FIG. 1, the gaming system 100 includes one or more gaming servers 102 which are managed or operated by gaming service providers and configured to enable registered players or registrants to participate in any one or more of a variety of gaming services over the one or more networks 110 provided. Accordingly, the gaming servers 102 may be configured to manage a plurality of databases including, for example, a registrant database and a gaming service database, among other things. Moreover, as is generally held in the art, each gaming server 102 may include one or more computational devices 112 having at least one processor 114 and at least one memory 116 for storing instructions configured to cause the one or more processors 114 of the gaming server 102 to perform one or more preprogrammed functions or operations.

The one or more gaming servers may be located proximately to or remotely from the clients 108. When located proximately, such as at a land-based casino location, the one or more gaming servers 102 may be considered to be part of a casino server. Alternatively, when located remotely, the one or more gaming servers 102 may be considered to be an on-line gaming server. Furthermore, the gaming system may include both one or more casino servers and one or more on-line gaming servers.

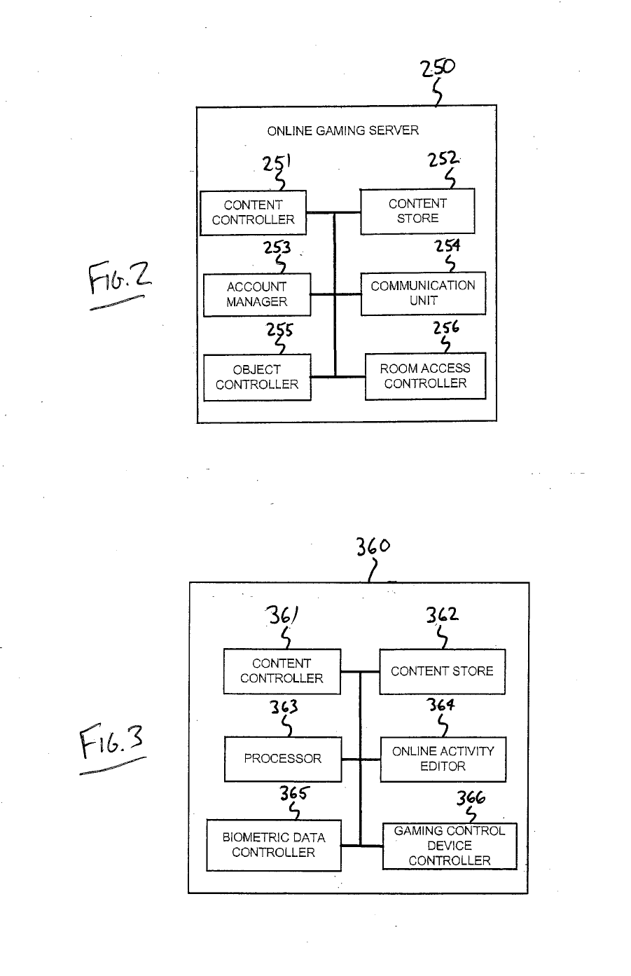

An example of an on-line gaming server 250 is schematically illustrated in greater detail in FIG. 2. The online gaming server 250 may be configured to control wagering game content, provide random numbers, and communicate wagering game information, account information, and other information to and from the clients 108. The online gaming server 250 may include a content controller 251 configured to manage and control content for the presentation of content on the clients 108. For example, the content controller 251 may generate game results, including win amounts, for games played on the clients 108, and communicate the game results to the clients 108. The content controller 251 may also generate random numbers and provide them to the client 108 so that the clients 108 may generate game results.

The online gaming server 250 may also include a content store 252 configured to contain content to present on the clients 108. The online gaming server 250 may also include an account manager 253 configured to control information related to player accounts. For example, the content controller 251 may communicate wager amounts, game results amounts (e.g., win amounts), award game amounts, etc., to the account server 106. The online gaming server 250 may also include a communication unit 254 configured to communicate information to the clients 108 and to communicate with other systems, devices and networks. For example, the communication unit 254 may track and communicate with community wagering game servers, account servers, community servers, social networking servers, file sharing servers, etc. The online gaming server 250 may also include an object controller 255 configured to control positions, movements, actions, functions, etc. of online gaming objects. The online gaming server 250 may also include a room access controller 256 configured to control access to online gaming venue rooms, including security and access levels based on player settings, player status, etc.

### Community Servers/Networks

The community servers 104 of FIG. 1 may be similarly managed or operated by social networks and include virtual communities, public forums, blogs, and the like. Such community servers 104 typically include databases for not only managing the web-based interfaces associated with one or more online communities, but also for managing databases of information pertaining to registrants or members as well as corresponding member profiles, registration information, user preferences, and the like. As with the gaming servers 102, services of the community servers 104 are accessible to registrants via client devices 108 and through the one or more networks 110 interconnecting the client 108 to the community servers 104. Specifically, the network 110 may take the form of a local area network (LAN), a wireless cellular data network, a wide area network (WAN) such as the internet, or any other suitable network or combination of networks enabling local and/or remote communications between the gaming servers 102, community servers 104, account servers 106, and clients 108.

### Account Servers

The account server 106 may be configured to control user related accounts accessible via wagering game networks, which may include land-based or on-line casino networks and social networks. The account server 106 may store and track player information, such as identifying information (e.g., avatars, screen name, account identification numbers, etc.) or other information like financial account information, social contact information, etc. The account server 106 may contain accounts for social contacts referenced by the player account. The account server 106 may also provide auditing capabilities, according to regulatory rules, and track the performance of players, machines, and servers.

As schematically illustrated in FIG. 1, the account server 106 may include an account controller 130 configured to control information for a player's account, an account store 132 configured to store information for a player's account, and a player preferences settings 134 configured to store settings associated with actions, skins, behaviors, multi-media files, music, and other information with a player account's indicated expressions of emotion, and/or a system imposed expression of an emotion, for an avatar or other object within the online gaming venue. The player preferences settings 134 may communicate information to the object controller 255 to apply the information stored in the settings to an avatar object associated with the player account.

### Client Devices

As depicted in the embodiment of FIG. 1, the client devices or clients 108 may take any one of a plurality of forms including a mobile device, a cellular phone, a smartphone, a tablet device, a laptop computer, a desktop computer, a stationary gaming machine, a portable gaming machine, or any other computational device having at least one input device 118 and at least one output device 120. The input device 118 may include any one or more of a mouse, a keypad, a keyboard, a touchpad, a touchscreen, a microphone, a camera, and any other device enabling the registered player to input information. The output device 120 may include any one or more of a monitor, a display screen, a touchscreen, a speaker, or any other output device enabling a gaming service to be presented to the player. The client device 108 also includes one or more processors 122 and at least one memory 124 for storing instructions configured to cause the processor 122 to, among other things, facilitate and/or provide an interface through which a player may participate in one or more gaming services sourced by the gaming servers 102 using the input devices 118 and output devices 120. Correspondingly, the client device 108 additionally includes at least one communication device 126, such as a modem, a receiver, a transmitter, a transceiver, a network card, an Ethernet card, or any other communication device having wired and/or wireless connectivity with the gaming servers 102 through the one or more networks 110.

The clients 108 may communicate with external systems (in a wired or wireless manner) such that each client 108 operates as a “thin client,” having relatively less functionality, a “thick client,” having relatively more functionality, or through any range of functionality therebetween (e.g., a “rich client”). When configured as a “thin client,” the client 108 may operate primarily as a display device to display the results of gaming outcomes processed externally, for example, on a server, which may be an external computing device or a “cloud” of computing devices that communicate and work together. In this “thin client” configuration, the external server executes game code and determines game outcomes (e.g., with a random number generator), while a controller on board the client 108 processes display information to be displayed on the display(s) 120.

In an alternative “rich client” configuration, the external server may determine game outcomes while the controller on board the client 108 executes game code and processes display information to be displayed on the display(s) 120. In yet another alternative “thick client” configuration, a controller on board the client 108 executes game code, determines game outcomes, and processes display information to be displayed on the display(s) 120. Numerous alternative configurations are possible such that the aforementioned and other functions may be performed onboard or external to the client 108 as may be necessary for particular applications. It should be understood that the clients 108 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

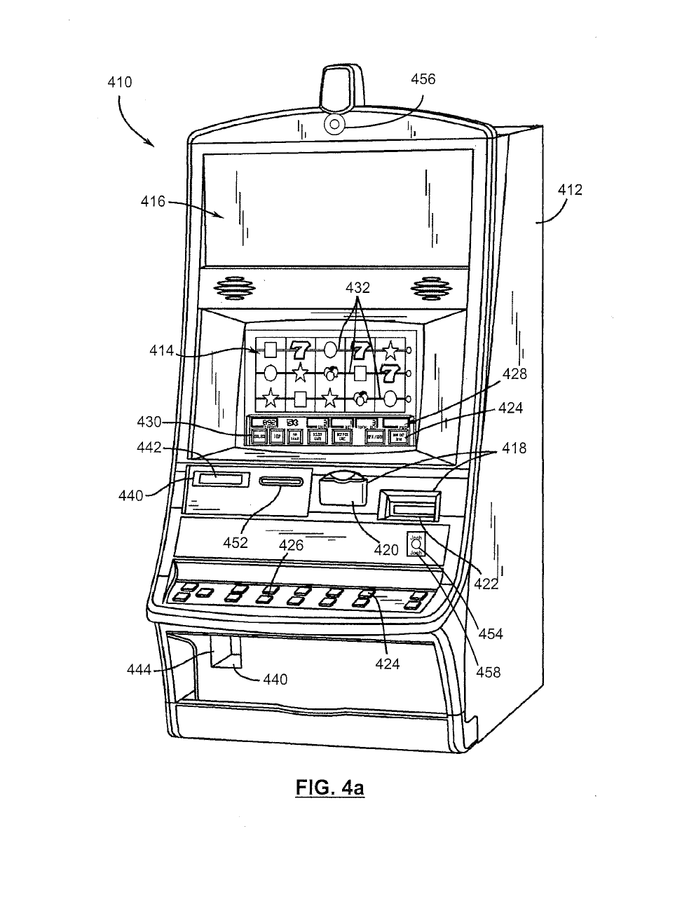

An embodiment of a client 108 is schematically illustrated as a computational device 360 in FIG. 3. The computational device 360 may be configured to present wagering games and receive and transmit information to control and present online wagering games. The computational device 360 may include a content controller 361 configured to manage and control content and presentation of online gaming venue content on the computational device 360. The computational device 360 may also include a content store 362 configured to contain content to present on the computer system 360. The computational device 360 may also include a processor 363 configured to process wagering game content, present online wagering game objects, control gaming devices, etc.

The computational device 360 may include an online activity editor 364 configured to record, modify, and share recorded online gaming activity. The online activity editor 364 may be configured to add comments, text, pictures and other multi-media modifications to the recorded online gaming activity files. The online activity editor 364 may share the recorded online gaming activity with other player accounts. The computational device 360 may also include a biometric data controller 365 configured to detect biometric data from one or more sensors and equipment attached to the computational device and transfer the data to the object controller to express one or more indications of emotions by a player account. The computer system 360 may also include a gaming control device controller 366 configured to detect and control devices, including a gaming pad, custom player control devices, login devices, etc. The gaming pad, for example, may be configured to move an avatar within the online gaming venue in a very fluid motion, much more fluidly than possible with a standard keyboard.

### Casino Gaming Machine

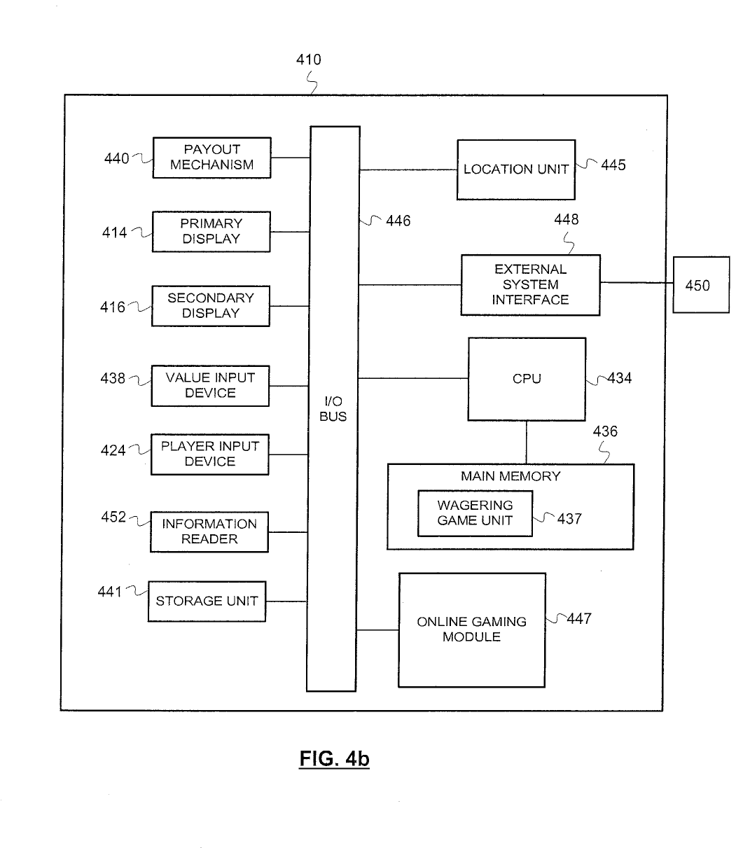

One type of client 108 may be a casino gaming machine 410 configured for use in a gaming establishment such as a casino, as illustrated in FIGS. 4a and 4b. The gaming machine 410 may be any type of gaming machine and may have varying structures and methods of operation. For example, the gaming machine 410 may be an electromechanical gaming machine configured to play mechanical slots, or it may be an electronic gaming machine configured to play a video casino game, such as slots, keno, poker, blackjack, roulette, etc.

The casino gaming machine 410 may include a housing 412 and may include input devices, including a value input device 418 and a player input device 424. For output, the gaming machine 410 may include a primary display 414 for displaying information about the wagering game. The primary display 414 may also display information about an award wagering game and a progressive wagering game. The gaming machine 410 may also include a secondary display 416 for displaying game events, game outcomes, and/or signage information. While these typical components found in the gaming machine 410 are described below, it should be understood that numerous other elements may exist and may be used in any number of combinations to create various forms of a gaming machine 410.

The value input device 418 may be provided in many forms, individually or in combination, and is preferably located on the front of the housing 412. The value input device 418 may receive currency and/or credits that may be inserted by a player. The value input device 418 may include a coin acceptor 420 for receiving coin currency (see FIG. 4a). Alternatively, or in addition, the value input device 418 may include a bill acceptor 422 for receiving paper currency. Furthermore, the value input device 418 may include a ticket reader, or barcode scanner, for reading information stored on a credit ticket, a card, or other tangible portable credit storage device. The credit ticket or card may also authorize access to a central account, which can transfer play credits to the casino gaming machine 410.

The player input device 424 may include a plurality of push buttons 426 on a button panel for operating the gaming machine 410. In addition, or alternatively, the player input device 424 may include a touch screen 428 mounted by adhesive, tape, or the like over the primary display 414 and/or secondary display 416. The touch screen 428 may include soft touch keys 430 denoted by graphics on the underlying primary display 414 and may be used to operate the gaming machine 410. The touch screen 428 may provide players with an alternative method of input. A player may enable a desired function either by touching the touch screen 428 at an appropriate touch key 430 or by pressing an appropriate push button 426 on the button panel. The touch keys 430 may be used to implement the same functions as push buttons 426. Alternatively, the push buttons 426 may provide inputs for one aspect of operating the game, while the touch keys 430 may allow for input needed for another aspect of the game. In some embodiments, a physical player sensor 456 may also be included. The physical player sensor 456 may be a camera or a biometric sensor or a motion detecting device. The physical player sensor 456 may be used to provide inputs to the game, such as images, selection motions, biometric data and other physical information.

The various components of the gaming machine 410 may be connected directly to, or contained within, the housing 412, as shown in FIG. 4a, or may be located outboard of the housing 412 and connected to the housing 412 via a variety of different wired or wireless connection methods. Thus, the gaming machine 410 may include these components whether housed in the housing 412, or outboard of the housing 412 and connected remotely.

The operation of the basic wagering game may be displayed to the player on the primary display 414. The primary display 414 may also display the award game associated with the basic wagering game. The primary display 414 may take the form of a cathode ray tube (CRT), a high resolution LCD, a plasma display, an LED, or any other type of display suitable for use in the gaming machine 410. As shown, the primary display 414 may include the touch screen 428 overlaying the entire display (or a portion thereof) to allow players to make game-related selections. Alternatively, the primary display 414 of the gaming machine 410 may include a number of mechanical reels to display the outcome in visual association with at least one payline 432. In the illustrated embodiment, the gaming machine 410 is an “upright” version in which the primary display 414 is oriented vertically relative to the player. Alternatively, the gaming machine may be a “slant-top” version in which the primary display 414 may be slanted at about a thirty-degree angle toward the player of the gaming machine 410.

A player may begin play of the basic wagering game by making a wager via the value input device 418 of the gaming machine 410. The value wagered may have a real money value or may be a virtual value that is not redeemable in cash. A player may select play by using the player input device 424, via the buttons 426 or the touch screen keys 430. The basic game may include of a plurality of symbols arranged in an array, and may include at least one payline 432 that indicates one or more outcomes of the basic game. Such outcomes may be randomly selected in response to the wagering input by the player. At least one of the plurality of randomly-selected outcomes may be a start-award outcome, which may include any variations of symbols or symbol combinations triggering a award game.

In some embodiments, the gaming machine 410 may also include a player information reader 452 that allows for identification of a player by reading a card 454 with player information 458 indicating his or her true identity. The player information reader 452 is shown in FIG. 4a as a card reader, but may take on many forms including a ticket reader, bar code scanner, RFID transceiver or computer readable storage medium interface. Currently, identification 458 may be generally used by casinos for rewarding certain players with complimentary services or special offers. For example, a player may be enrolled in the gaming establishment's loyalty club and may be awarded certain complimentary services as that player collects points in his or her player-tracking account. The player may insert his or her card 454 into the player information reader 452, which allows the casino's computers to register that player's wagering at the gaming machine 410. The gaming machine 410 may use the secondary display 416 or other dedicated player-tracking display for providing the player with information about his or her account or other player-specific information. Also, in some embodiments, the information reader 452 may be used to recall or restore game assets that the player achieved and saved during a previous game session either in the gaming establishment or on a separate computing device at a different location.

Turning now to FIG. 4b, the various components of the gaming machine 410 may be controlled by a central processing unit (CPU) 434, also referred to herein as a controller or processor (such as a microcontroller or microprocessor). The controller 434 may include any suitable processor, such as an Intel® Pentium processor, Intel® Core 2 Duo processor, AMD Opteron™ processor, or UltraSPARC processor. To provide gaming functions, the controller 434 may execute (or be physically configured according to) one or more game programs stored in a computer readable storage medium, in the form of a main memory 436. The main memory 436 may include a volatile memory (e.g., a random-access memory (RAM)) and a non-volatile memory (e.g., an EEPROM). The main memory 436 may include multiple RAM and multiple program memories. The main memory 436 may further include a wagering game unit 437. In some embodiments, the wagering game unit 437 may present wagering games having a casino game format, such as video poker, video black jack, video slots, video lottery, reel slots, etc., in whole or in part. Alternatively, the wagering games may be in a casual or social game format, as described in greater detail below.

The controller 434 may perform the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It may be appreciated that the controller 434 may include one or more microprocessors, including but not limited to a master processor, a slave processor, and a secondary or parallel processor.

The controller 434 may also be coupled to a value input device 438. The value input device 438 may signal the processor that money and/or credits have been input via the value input device 418. These components may be located within the housing 412 of the gaming machine 410 or, as explained above, may be located outboard of the housing 412 and connected to the remainder of the components of the gaming machine 410 via a variety of different wired or wireless connection methods.

As seen in FIG. 4b, the controller 434 also may be connected to, and may control, the primary display 414, the player input device 424, a payout mechanism 440, and a storage unit 441. The payout mechanism 440 may be operable in response to instructions from the controller 434 to award a payout to the player in response to certain winning outcomes that might occur in the basic game or the award game(s). The payout may be provided in the form of points, bills, tickets, coupons, cards, etc. For example, in FIG. 4a, the payout mechanism 440 may include both a ticket printer 442 and a coin outlet 444. However, any of a variety of payout mechanisms 440 well known in the art may be implemented, including cards, coins, tickets, smartcards, cash, etc. The payout amounts distributed by the payout mechanism 440 may be determined by one or more pay tables stored in the main memory 436.

An input/output (“I/O”) bus 446 may provide communications between the controller 434 and the peripheral components of the gaming machine. The I/O bus 446 may include any suitable bus technologies, such as an AGTL+ frontside bus and a PCI backside bus. More specifically, the controller 434 may control and receive inputs from the peripheral components of the gaming machine 410 through the I/O bus 446. The I/O bus 446 also may be connected to an external system interface 448, which in turn is connected to external systems 450. The external systems 450 may include a gaming network, other gaming machines, a gaming server, communications hardware, or a variety of other interfaced systems or components. The controller 434 may communicate with the external systems 450 via the external system interface 448 and a communication path (e.g., serial, parallel, IR, RC, 10bT, etc.) The external system interface 448 may include logic for exchanging information over wired and wireless networks (e.g., 802.11g transceiver, Bluetooth transceiver, Ethernet transceiver, etc.). Although the I/O bus 446 and external system interface 448 may be illustrated as single blocks, it should be appreciated that each may include a number of different types of I/O circuits.

The I/O bus 446 further may be connected to a location unit 445. The location unit 445 may create player information that indicates the wagering game machine's location/movements in a casino. In some embodiments, the location unit 445 includes a global positioning system (GPS) receiver that can determine the wagering game machine's location using GPS satellites. In other embodiments, the location unit 445 may include a radio frequency identification (RFID) tag that can determine the wagering game machine's location using RFID readers positioned throughout a casino. Some embodiments can use GPS receivers and RFID tags in combination, while other embodiments may use other suitable methods for determining the wagering game machine's location. Although not shown in FIG. 4b, in some embodiments the location unit 445 is not connected to the I/O bus 446.

In some embodiments, the wagering game machine 410 may include an online gaming module 447. The online gaming module 447 may process communications, commands, or other information, where the processing may control and present online wagering games.

Controller 434, as used herein, may include any combination of hardware, software, and/or firmware, that may be disposed or resident inside and/or outside of the gaming machine 410, which may communicate with and/or control the transfer of data between the gaming machine 410 and a bus, another computer, processor, or device and/or a service and/or a network. The controller 434 may include one or more controllers or processors. In FIG. 4b, the controller 434 in the gaming machine 410 is depicted as comprising a CPU, but the controller 434 may alternatively include a CPU in combination with other components, such as the I/O bus 446, the external system interface 448, and the main memory 436. The controller 434 may reside partially or entirely inside or outside of the machine 410. The control system for a mobile gaming machine (disclosed below) may be similar to the control system for the free standing gaming machine 410 except that the functionality of the respective on-board controllers may vary.

### Mobile Gaming Machine

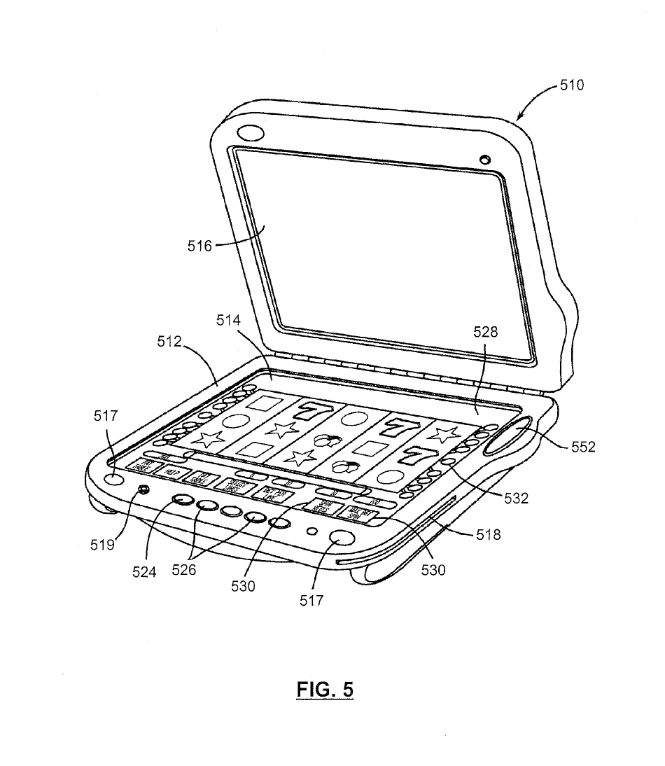

Another type of client 108 may be a handheld or mobile gaming machine 510, illustrated in FIG. 5. Like the free standing casino gaming machine 410, the mobile gaming machine 510 may be an electronic gaming machine configured to play a casino game such as, but not limited to, slots, keno, poker, blackjack, and roulette. The mobile gaming machine 510 may include a housing or casing 512 and may include input devices, including a value input device 518 and a player input device 524. For output, the mobile gaming machine 510 may include, but is not limited to, a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the mobile gaming machine 510 may include a secondary display 516 that is rotatable relative to the primary display 514. The optional secondary display 516 may be fixed, movable, and/or detachable/attachable relative to the primary display 514. Either the primary display 514 and/or secondary display 516 may be configured to display any aspect of a wagering game, an award game, a progressive wagering game, a group game, a shared-experience game or event, a game event, a game outcome, scrolling information, text messaging, an emails, an alert or announcement, broadcast information, subscription information, and mobile gaming machine status.

The player-accessible value input device 518 may include, for example, a slot located on the front, side, or top of the casing 512 configured to receive credit from a stored-value card (e.g., casino card, smart card, debit card, credit card, etc.) inserted by a player. In another aspect, the player-accessible value input device 518 may include a sensor (e.g., an RF sensor) configured to sense a signal (e.g., an RF signal) output by a transmitter (e.g., an RF transmitter) carried by a player. The player-accessible value input device 518 may also or alternatively include a ticket reader, or barcode scanner, for reading information stored on a credit ticket, a card, or other tangible portable credit or funds storage device. The credit ticket or card may also authorize access to a central account, which may transfer money or play credits to the mobile gaming machine 510.

Still other player-accessible value input devices 518 may require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player may be permitted to access a player's account. As one potential optional security feature, the mobile gaming machine 510 may be configured to permit a player to only access an account the player has specifically set up for the mobile gaming machine 510. Other conventional security features may also be utilized to, for example, prevent unauthorized access to a player's account, to minimize an impact of any unauthorized access to a player's account, or to prevent unauthorized access to any personal information or funds temporarily stored on the mobile gaming machine 510.

The player-accessible value input device 518 may itself include or utilize a biometric player information reader which permits the player to access available funds on a player's account, either alone or in combination with another of the aforementioned player-accessible value input devices 518. In an embodiment wherein the player-accessible value input device 518 include a biometric player information reader, transactions such as an input of value to the mobile device, a transfer of value from one player account or source to an account associated with the mobile gaming machine 510, or the execution of another transaction, for example, may all be authorized by a biometric reading, which may include a plurality of biometric readings, from the biometric device.

Alternatively, to enhance security, a transaction may be optionally enabled only by a two-step process in which a secondary source confirms the identity indicated by a primary source. For example, a player-accessible value input device 518 may include a biometric player information reader which may require a confirmatory entry from another biometric player information reader 552, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) may be utilized to provide enhanced security prior to the electronic transfer of any funds. In another aspect, the value input device 518 may be provided remotely from the mobile gaming machine 510.

The player input device 524 may include a plurality of push buttons on a button panel for operating the mobile gaming machine 510. In addition, or alternatively, the player input device 524 may include a touch screen 528 mounted to a primary display 514 and/or secondary display 516. In one aspect, the touch screen 528 may be matched to a display screen having one or more selectable touch keys 530 selectable by a user's touching of the associated area of the screen using a finger or a tool, such as a stylus pointer. A player may enable a desired function either by touching the touch screen 528 at an appropriate touch key 530 or by pressing an appropriate push button 526 on the button panel. The touch keys 530 may be used to implement the same functions as push buttons 526. Alternatively, the push buttons may provide inputs for one aspect of the operating the game, while the touch keys 530 may allow for input needed for another aspect of the game. The various components of the mobile gaming machine 510 may be connected directly to, or contained within, the casing 512, as seen in FIG. 5, or may be located outboard of the casing 512 and connected to the casing 512 via a variety of hardwired (tethered) or wireless connection methods. Thus, the mobile gaming machine 510 may include a single unit or a plurality of interconnected parts (e.g., wireless connections) which may be arranged to suit a player's preferences.

The operation of the basic wagering game on the mobile gaming machine 510 may be displayed to the player on the primary display 514. The primary display 514 may also display the award game associated with the basic wagering game. The primary display 514 may take the form of a high resolution LCD, a plasma display, a LED, or any other type of display suitable for use in the mobile gaming machine 510. In some embodiments, the gaming machine 510 may be provided as a portable phone, portable gaming console, or other specific or multi-purpose hand-held device, in which case the primary display 514 may be the display provided with such a device. The size of the primary display 514 may vary from, for example, about a 2-3″ display to a 15″ or 17″ display. In at least some embodiments, the primary display 514 may be a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 514 and/or secondary display 516 may have a 16:9 aspect ratio or other aspect ratio (e.g., 4:3) and the aspect ratio may be modified depending on the game and use of the device. The primary display 514 and/or secondary display 516 may also each have different resolutions, different color schemes, and different aspect ratios.

As with the free standing casino gaming machine 410, a player may begin play of the basic wagering game on the mobile gaming machine 510 by making a wager (e.g., via the value input device 518 or an assignment of credits stored on the mobile gaming machine 510 via the touch screen keys 530, player input device 524, or buttons 526) on the mobile gaming machine 510. In at least some aspects, the basic game may include a plurality of symbols arranged in an array, and includes at least one payline 532 that indicates one or more outcomes of the basic game. Such outcomes may be randomly selected in response to the wagering input by the player. At least one of the plurality of randomly selected outcomes may be a start-award outcome, which can include any variations of symbols or symbol combinations triggering a award game.

In some embodiments, the player-accessible value input device 518 of the mobile gaming machine 510 may double as a player information reader 552 that allows for identification of a player by reading a card 354 (FIG. 3) with information indicating the player's identity (e.g., reading a player's credit card, player ID card, smart card, etc.). The player information reader 552 may alternatively or also include a bar code scanner, RFID transceiver or computer readable storage medium interface. In one embodiment, the player information reader 552, shown by way of example in FIG. 5, may include a biometric sensing device.

### Gaming System Security

Security features are advantageously utilized where the gaming machines 410, 510 communicate wirelessly with external systems, such as through wireless local area network (WLAN) technologies, wireless personal area networks (WPAN) technologies, wireless metropolitan area network (WMAN) technologies, wireless wide area network (WWAN) technologies, or other wireless network technologies implemented in accord with related standards or protocols (e.g., the Institute of Electrical and Electronics Engineers (IEEE) 802.11 family of WLAN standards, IEEE 802.11i, IEEE 802.11r (under development), IEEE 802.11w (under development), IEEE 802.15.1 (Bluetooth), IEEE 802.12.3, etc.). For example, a WLAN in accord with at least some aspects of the present concepts may include a robust security network (RSN), a wireless security network that allows the creation of robust security network associations (RSNA) using one or more cryptographic techniques, which provides one system to avoid security vulnerabilities associated with IEEE 802.11 (the Wired Equivalent Privacy (WEP) protocol). Constituent components of the RSN may include, for example, stations (STA) (e.g., wireless endpoint devices such as laptops, wireless mobile devices, cellular phones, mobile gaming machine 510, etc.), access points (AP) (e.g., a network device or devices that allow(s) an STA to communicate wirelessly and to connect to a(nother) network, such as a communication device associated with I/O circuit(s) 448), and authentication servers (AS) (e.g., an external system 450), which provide authentication services to STAs. Information regarding security features for wireless networks may be found, for example, in the National Institute of Standards and Technology (NIST), Technology Administration U.S. Department of Commerce, Special Publication (SP) 800-97, ESTABLISHING WIRELESS ROBUST SECURITY NETWORKS: A GUIDE TO IEEE 802.11, and SP 800-48, WIRELESS NETWORK SECURITY: 802.11, BLUETOOTH AND HANDHELD DEVICES, both of which are incorporated herein by reference in their entirety.

### Client Interface—Registration

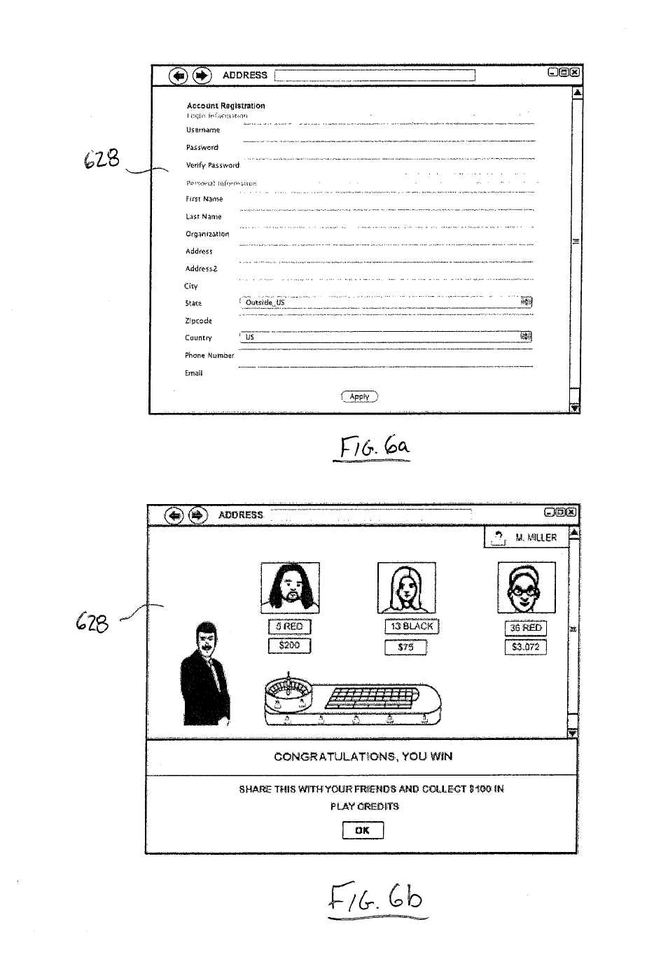

Among other things, the clients 108 may be configured to communicate with the gaming servers 102 to retrieve gaming service data, display gaming service data, operate a gaming service on the client devices 108, and communicate any relevant input provided by the player and received through the one or more input devices 118 back to the gaming servers 102. Gaming service data may be initially retrieved from the gaming servers 102 by request of the player at the client 108. Specifically, the player can initiate the request by navigating a web browser, or the like, within the client device 108 to one or more network or internet addresses associated with and/or managed by the gaming servers 102. Upon receiving the request, the gaming servers 102 communicate gaming service data associated with the desired gaming service through the network 110 to be downloaded, installed and executed on the client device 108. The gaming service data may contain information which, once downloaded and installed within the client device 108, creates an interface 628, such as the web-based interface shown in FIGS. 6a and 6b, a standalone application-based interface, or the like, that is supported by the operating system of the client device 108, through which the player may participate and/or interact with the gaming service.

The interface 628 provided to the player via the client 108 can be configured in a number of different ways to facilitate interactions between the player and the gaming service. As shown in FIG. 6a for instance, the interface 628 may be used to receive registration information from a new user so as to register the user with one or more gaming services and to store the player information in the database or memory 116 associated with the gaming servers 102. More particularly, the interface 628 may be used to gather information such as the player's name, mailing address, contact information, electronic mailing address, and the like. The registration interface 628 may also enable the player to establish a desired alias, username or login, as well as corresponding passwords or other login credentials.

### Client Interface—Gameplay

In addition, the interface 628 can be used to enable play of a wagering game or otherwise facilitate player participation. As noted above, the wagering game may be a game of chance, a contest, a social (i.e., “play-for-fun”) game, a sweepstake, or other gaming content provided by the gaming servers 102, as shown in FIG. 6b. For example, while displaying images, video, audio, and/or any other media pertaining to play of a wagering game, the interface 628 may also be configured to receive various inputs from the player during gameplay. Based on the type of client device 108 being used and the types of input devices 118 available to the player, for example, the player may provide game input using actions such as mouse-clicks, keystrokes, mouse gestures, finger or hand gestures, voice commands, and the like. Such player input is read by the client device 108 and used to determine the corresponding actions and/or selections that are desired by the player. The relevant actions and/or selections can then be communicated to the respective gaming servers 102 in a manner which enables the player to gain entry into contests or sweepstakes, advance through levels or stages of a game of chance, acquire cash-redeemable credits or virtual currency, rewards, points, and the like.

### Player Accounts

Player accounts may be used to store, track, and update information associated with registered players of the wagering game. Each registered player may have an associated player account. For example, a first player account may be associated with a first player, a second player account may be associated with a second player, and so on. Each player account may include account information associated with a respective registered player. In addition to the player information noted above, each player account may include additional information related to play of the wagering game, such as information indicative of an amount of money, virtual currency, or other assets attributed to the player associated with the player account. The assets may be configured for use in the wagering game or other games. For example, the player account may include a real credit balance indicative of real credits available for wagering in a casino-style wagering game, a virtual credit balance indicative of an amount of virtual credits available for wagering in a social/casual type wagering game, and/or other account information that tracks other assets or attributes that may be used in the casino, social/casual, or other type of wagering game. The player accounts may be stored on a remote server, such as the account server 106. Alternatively, the player accounts may be stored locally, such as on a gaming device 410, 510, stationary or portable PC, on-site server (e.g., a casino server), or other computational device 360.

### Gift Value

A gift value may be an amount of assets designated by a first player for gifting to a second player. For example, the first player account may be configured to permit the first player to designate a specified amount of assets as the gift value to be transferred. The gift value may include real credits, bonus credits, or other assets having a nominal cash value that may be wagered in a wagering game. In other embodiments, the gift value may have no direct monetary value. For example, the gift value may include virtual credits, a bonus game, a bonus mechanic, a bonus item, or other virtual attributes that may be wagered or otherwise used in a social game. The amount of assets designated for gifting may be selected by the first player, pre-determined by the wagering game, or otherwise determined by the one or more gaming servers 102.

In some embodiments, the first player may select the amount of assets held in the first player account to be designated as the gift value.

In other embodiments, the first player may earn a predetermined amount of gift currency that may be designated as the gift value. The gift currency may be wagered in the wagering game only after it has been transferred from the first player to the second player. The player accounts stored on the account server 106 may include gift currency balances to identify and track the amount of gift currency each player may have. The gift currency may have a cash value usable in wagering games that accept monetary wagers, or may have a virtual value that is not redeemable for cash but may be used in wagering games that accept virtual credits (i.e., social and casual games).

The gift currency may accrue in the first player account based on activities of the first player. In some embodiments, a predetermined amount of gift currency may be credited to the first player account based on a deposit made into the first player account. For example, the wagering game may be configured to credit the first player account with $50 of gift currency when a matching deposit of $50 is made into the first player account. In other embodiments, the gift currency may be credited to the first player account based on play of the wagering game by the first player. For example, when the first player completes an achievement in the wagering game, such as reaching a threshold coin-in, obtaining a particular game outcome, or achieving any other pre-determined metric associated with play of the wagering game, a predetermined amount of gift currency may be credited to the first player account.

### Transfer of Gift Value Between Player Accounts

To execute a gifting transaction, the first player may interface with a computational device 360 provided on the gaming system 100, such as the account server 106. During this interface, the first player may be prompted to identify the second player to which the gift value is to be transferred, select the type of asset (i.e., real credit, virtual credit, virtual attribute, etc.) to be transferred, select a nominal value (i.e., $50, 50 virtual credits, etc.) of the asset, and to provide other information defining the gift value. The account server 106 may then update the balances of the first and second player accounts to reflect the gifting transaction. As noted above, in some implementations the first player may select the amount of assets to transfer as the gift value. In other implementations, the first player may accrue a predetermined amount of gift currency, and the gift value may be all or a portion of that amount of gift currency.

### Wagering of Gift Value

The second player may wager the gift value in the wagering game. The one or more gaming servers 102 may discern whether a wager by the second player was made using the gift value or other assets. In some embodiments, the one or more gaming servers 102 may communicate with the account server 106 to determine whether the wager is made using assets from a gifted balance associated with the second player account. In other embodiments, the one or more gaming servers 102 may determine the wagering of the gift value by the use of gift currency to make the wager.

In some implementations, the first and/or second player may select when to wager the gift value using the inputs 118 of a client device 108. For example, the display 120 may show a “gift play” setting that may be controlled by a selected one of the first and second players. The one or more gaming servers 102 may be configured to allow the first player to activate the gift play setting, thereby allowing or requiring the gift value to be wagered. Alternatively, the second player may control activation of the gift play setting, thereby giving the second player the option to determine when the gift value is wagered. Still further, activation of the gift play setting may be dependent on both the first and second players, and the gift value may be wagered only when both players activate the gift play setting. The one or more gaming servers 102 may determine whether the gift play setting is activated to determine whether the gift value is to be wagered.

In other implementations, the gaming system 100 may select when the gift value is used as the wager. For example, the one or more gaming servers 102 may be configured to randomly select when the gift value is wagered while the second player plays a session on the wagering game. After the second player selects a wager amount, and prior to the draw, the one or more gaming servers 102 may select whether the wager amount is to be debited from the gifted balance. Determining when the gift value is wagered may be based on a random number generator, a wheel spin, or other process for randomly selecting when the gift value is wagered in the wagering game. The one or more gaming servers 102 may be configured to operate the display 120 to provide an indicator or other notification that the gift value is currently being wagered in the wagering game.

Alternatively, the one or more gaming servers 102 may be configured to apply the gift value at a predetermined period during a play session. For example, the one or more gaming servers 102 may require all gift value associated with the second player account to be used before allowing the second player to wager from other balances stored on the account. Additionally or alternatively, the one or more gaming servers 102 may periodically select to wager portions of the gift value at regular or random intervals throughout the play session.

Use of the gift value by the second player may be unconditional or restricted. In some implementations, the gift value may be allocated to a withdrawable balance stored in the second player account, which imposes no restriction on the immediate withdrawal of funds. In other implementations, the gift value may be allocated to a gifted balance stored in the second player account, which may have restrictions on withdrawal. For example, funds allocated to a gifted balance may not be immediately available for withdrawal until specific gameplay requirements are satisfied, although these funds may be immediately available for wagering in the wagering game.

Funds allocated to the gifted balance may be converted to the withdrawable balance based on a playthrough requirement. As used herein, a playthrough requirement is a threshold amount of wagering on the wagering game that is required before a gifted balance may be converted to a withdrawable balance. In some embodiments, the entire amount of the gifted value must be played to fulfill the playthrough requirement.

The wager made by the second player in the wagering game may be an aggregate wager, in which other assets in addition to the gift value are at risk in the wagering game. In some embodiments, a separate wager value may be associated with the second player account, and the aggregate wager may include both the gift value and the separate wager value. For example, the aggregate wager may be for a total of 100 credits, which may include a gift value of 50 credits and a separate wager value (taken from pre-existing assets of the second player) of 50 credits. The separate wager value may be assets contributed by the second player, or may be other gift values from other players.

The wager made by the second player in the wagering game may be attributed solely to the second player account. That is, when the gift value and any separate wager value are wagered as an aggregate wager, the total value of the aggregate wager may be debited directly from the second player account. Consequently, the second player may receive all or portions of any out-of-game or in-game benefits attributable to the wager. An out-of-game benefit may include points in a loyalty program, entries in a sweepstakes, comp credits, or other benefits provided outside of the wagering game. An in-game benefit may include any advantage the game may provide for maximum or high-level wager levels, such as qualification for a progressive jackpot, qualification for a bonus game, awarding of a bonus game mechanic, or other benefit provided directly within the wagering game. Even when the players have agreed to share the winnings (as described in greater detail below), the second player may receive all or a disproportionate amount of the benefits associated with the aggregate wager.

### Gift Win Amount

A gift win amount may be determined based on the outcome of the wagering game when the gift value is wagered. Accordingly, the gift win amount is indicative of the amount of assets accrued from winning outcomes of the wagering game when the gift value is wagered. The gift win amount may be a monetary value or a virtual value that is not redeemable for cash. The one or more gaming servers 102 may communicate with the account server 106 to track the gift win amount.

In some implementations, the gift win amount may be based on a payout percentage associated with the wagering game. The payout percentage is the theoretical percentage of coin in (whether real or virtual) that the wagering game will pay back in winning game outcomes, and may alternatively be expressed as the expected value of the game. In slot games, the payout percentage is reflected in one or more payout tables that define predetermined payouts for specific game outcomes. A slot game may have more than one payout table, such as a base game payout table, a bonus game payout table, and a progressive game payout table. The amounts of the winning outcomes and the theoretical probability with which those outcomes will occur determine the overall payout percentage of the slot game.

To provide incentive for gifting transactions, the wagering game may be configured to dynamically adjust the payout percentage when the gifted value is wagered. In some implementations, the wagering game may adjust the payout table. For example, when wagering with non-gifted values, a base game payout table may be used to determine payout amounts for winning game outcomes and a gift game payout table may be used when the gifted value is wagered. The gift game payout table may have a higher expected value than the base game payout table. In other implementations, the wagering game may adjust the probability of a winning outcome. For example, a higher frequency of winning outcomes may occur when the gift value is wagered than when non-gifted values are wagered. The increased payout and/or win frequency may apply any time the gift value is wagered, or may be selectively applied whenever a specific event (e.g. a bonus round, scatter pay, etc.) is triggered with a wager of the gift value. The use of gift money, therefore, may increase the payout percentage, thereby encouraging gifting transactions between players.

### Allocating Gift Win Amount Between Players

The gift win amount resulting from a successful game outcome based on a wager of the gift value may be allocated between the first and second players according to various allocation arrangements. The account server 106 and/or game servers 102 may be configured to apply a specific allocation arrangement to the gift win amount. In some implementations, the allocation arrangement may provide for the first player account to receive the entire gift win amount. Alternatively, the allocation arrangement may provide for the first and second player accounts to each receive 50% of the gift win amount. Other allocation arrangements may split the gift win amount among the first and second player accounts using different share percentages, which may range from 0 to 100%.

The share percentages used to allocate the gift win amount between players may be fixed or static, or may be variable or dynamic. A dynamic share percentage may be used to encourage or reward certain player activities. For example, a dynamic share percentage may be based on a status level associated with the player, where a player with a lower status level will receive a smaller share percentage and a player with a higher status level will receive a higher share percentage.

In some embodiments, a dynamic share percentage may be based on the type of player to which the gift value is given. For example, when the second player receiving the gift value is a previously registered or existing player, the first player may receive an existing account share percentage. Alternatively, when the second player is a new player, the first player may receive a new account share percentage that is greater than the existing account share percentage.

In other embodiments, a dynamic share percentage may be based on the amount of the gift value. For example, when the gift value is below a predetermined gift level threshold, such as $25, the first player may receive a first gift level share percentage. Conversely, when the gift value is above the gift level threshold, the first player may receive a second gift level share percentage that is greater than the first gift level share percentage.

Similar to the use of the gift value by the second player, use of the gift win amount may be restricted. More specifically, the shares of the gift win amount attributable to winning outcomes of the wagering game with a gift value wager may be applied to the gifted balances associated with the respective players. As noted above, the account server 106 and one or more game servers 102 may be configured so that assets held in a gifted balance are not immediately withdrawable but instead require playthrough before they can be withdrawn.

### Algorithms/Methods for Managing Gifting in a Gaming Environment

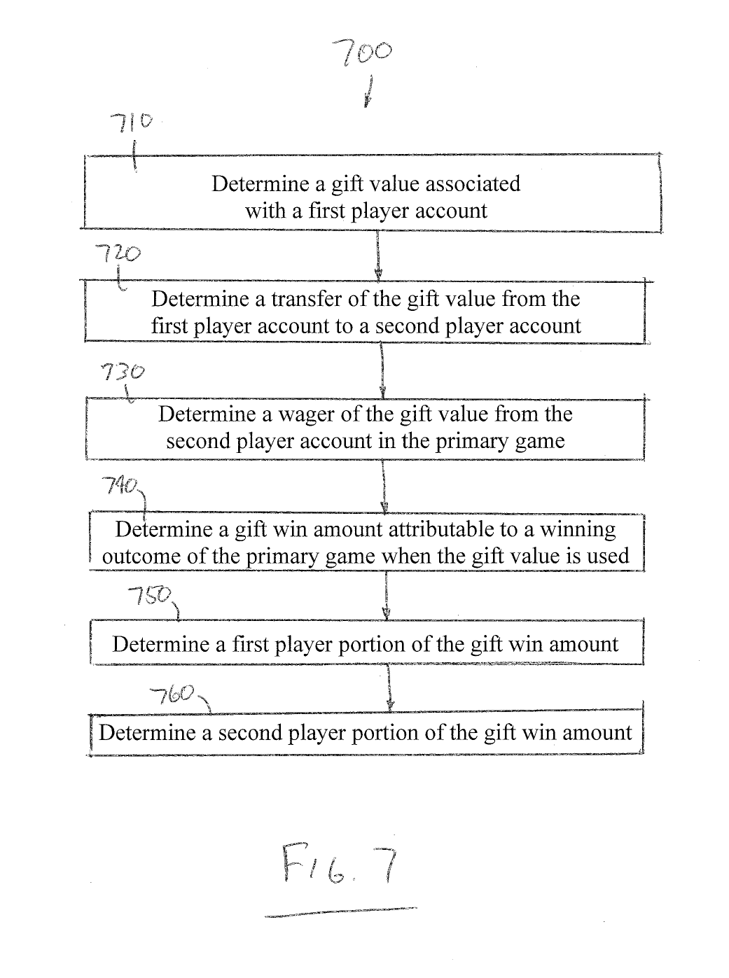

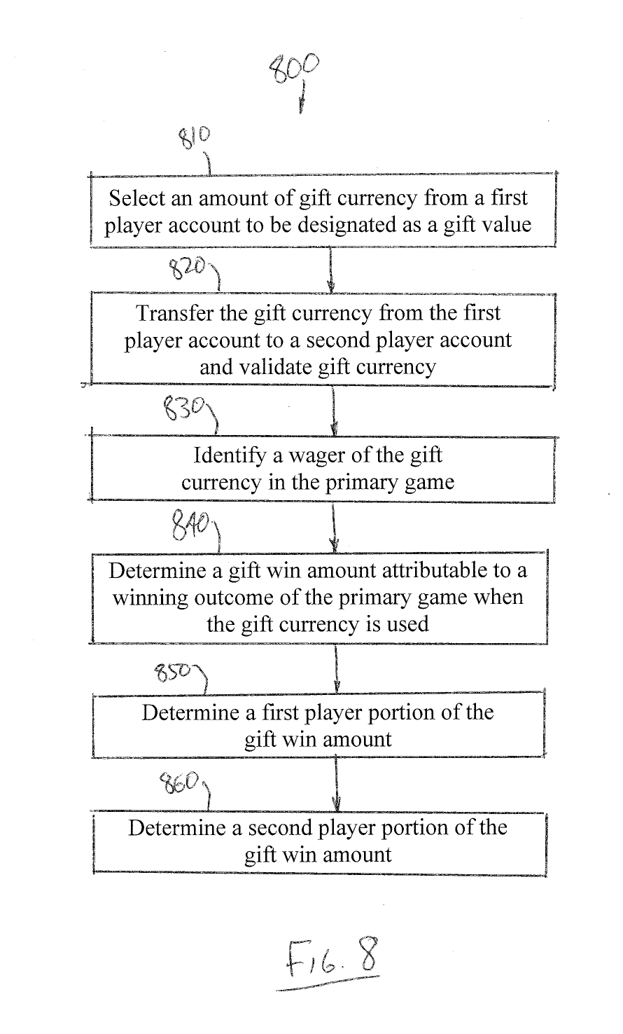

Turning to FIGS. 7 and 8, exemplary embodiments of algorithms or methods are provided by which one or more of the processors of the gaming system 100 may be configured to operate. The processors may include any one or more of a controller, a microcontroller, a microprocessor, a central processing unit (CPU), a field programmable gate array (FPGA), a digital signal processor (DSP), or any other suitable means for electronically controlling functionality of the gaming servers 102, community servers 104, account servers 106, and/or clients 108. Instructions for operating the one or more processors may be provided within the memory 114, such as a read only memory (ROM), random access memory (RAM), magnetic disk storage media, optical storage media, flash memory, or the like, that is locally or remotely disposed in communication with the processors.

As shown in FIG. 7, a method 700 of managing gifting in a gaming environment may be provided. The gifting may take place in a wagering game, which may be a wagering game accessible from a real world or on-line casino, a social game (i.e., a “play-for-fun” game), or other type of game content. The wagering game may be accessed by a computational device 360, such as the free-standing gaming machine 410, the mobile gaming machine 510, a stationary or portable PC, or other computing device.

At block 710, the processors of the gaming servers 102 and/or account servers 106 may be configured to determine a gift value that is associated with a first player account. More specifically, the processors may supply data which can be communicated to and downloaded by the client devices 108 over one or more networks 110 to generate and display an account interface using, for example, a web browser, a standalone application or program, or the like, within the client devices 108. Through the account interface, and using one or more input devices 118 of the client 108, a first player may access an associated first player account, select an asset from one or more account balances to be designated as the gift value, and select a second player as an intended beneficiary of the gift value. Any or all of the information submitted by the player may be communicated back to the gaming servers 102 and account server 106 and stored within a database or memory associated therewith.

Based on the information received from the first player, the processors of the gaming server 102 and/or account server 106 may be configured to transfer the gift value from the first player account to a second player account, as shown at block 720. In particular, the servers may debit an account balance of the first player account by the gift value amount, and credit an account balance of the second player account with the gift value amount.

Once the gift value has been transferred to the second player account, at block 730 the processors of the gaming servers 102 and/or account server 106 may be configured to determine when the gift value is wagered in the wagering game. More specifically, the processors may present the wagering game on a display 120 of the client 108 and allow the second player to select when to wager the gift value. Alternatively, the processors may be configured to select when the gift value will be wagered.

When the gift value is wagered in the wagering game, the processors of the gaming servers 102 and/or account server 106 may be configured to determine a gift win amount that is attributable to a winning outcome, as shown at block 740. In particular, the processors may be configured to determine the gift win amount based on a payout percentage associated with the wagering game. As noted above, the payout percentage may be dynamically adjusted to an increased percentage for winning outcomes that occur when the gift value amount is wagered.

The processors of the gaming servers 102 and/or account server 106 may be configured to determine how the gift win amount is shared by the first and second players, as shown at blocks 750 and 760. More specifically, the processors may be configured to allocate shares of the gift win amount according to first and second player share percentages. The first and second player share percentages may be predetermined and stored at the gaming servers 102 and/or account server 106. The processors may apply the respective player share percentages to the gift win amount and communicate first and second player shares to the account server 106. The processor of the account server 106 may be configured to update the gifted balance, real credit balance, virtual credit balance, or other asset balance associated with each player account to reflect the respective share of the gift win amount to be credited.

### Gift Currency Algorithm/Method

FIG. 8 illustrates an algorithm or method 800 of managing gifting in a gaming environment using a gift currency. The method 800 is similar to the method 700 described above, but is modified to more particularly disclose how the gift currency may be used during gift management.

At block 810, the processors of the gaming server 102 and/or account server 106 may be configured to allow the first player to select an amount of gift currency to be designated as the gift value. More specifically, the processors may be configured to accrue an amount of gift currency based on deposits made into the first player account and/or achievements obtained during play of the wagering game by the first player. The processors of the gaming server may communicate data to the account server 106 indicating the amount of gift currency to accrue to the first player. In response, the account server 106 may update a gift currency balance associated with the first player account. The first player account may be configured to permit the first player to select some or all of the gift currency balance to designate as a gift value.

The processors of the gaming server 102 and/or account server 106 may be configured to transfer the gift currency from the first player account to the second player account, as shown at block 820. The processors may communicate data indicative of the gift amount of gift currency to the gaming server 102. More specifically, the gaming server 102 may be configured to update the gift currency balance of the first player account to reflect a debit of gift currency, and to update the gift currency balance of the second player account to reflect a credit of the gift currency. In some implementations, the gift currency may be playable only after a gift transaction has been made, and therefore the step of determining a transfer of the gift currency may also be configured to validate the gift currency for use in the wagering game.

At block 830, the processors of the gaming server 102 and/or the account server 106 may be configured to determine when the gift currency is wagered in the wagering game. In this embodiment, where the gift value comprises a gift currency that may be separately tracked in the player accounts, determining when a wager of the gift value may be relatively straightforward. That is, the gaming system 100 may determine that the gift value has been wagered simply by determining that the gift currency was used to make the wager.

The processors of the gaming server 102 and/or account server 106 may be configured to determine a gift win amount attributable to a winning outcome of the wagering game when the gift currency is used, as shown at block 840. The gift win amount may be designated as an asset that may be immediately withdrawn, as additional gift currency which may have withdrawal or playthrough restrictions, or as other types of assets. At blocks 850 and 860, the respective first and second player portions of the gift win amount may be determined.

The wagering game may have any one of various game formats. Examples of game formats may include a cash value wagering game format, in which a monetary value may be wagered, and a virtual value wagering game format, in which the wagering game may be played for free or with virtual currency (i.e., a “play-for-fun” game format commonly provided on social websites). Additionally, the wagering game may be conducted at any one of various game venues. Examples of game venues may include a land-based casino, an on-line casino, a social website accessed via a home computer, and an application on a mobile device.

As noted above, the disclosure of “a” first player and “a” second player is intended to encompass “at least one” first player and “at least one” second player, respectively. That is, in certain embodiments, a plurality of first players (i.e., “donor” players) may transfer gift values to one or more second players (i.e., “donee” players).

FIGS. 6-8, described by way of example above, represent algorithms that correspond to at least some instructions executed by one of the computational devices illustrated in FIGS. 1-5 to perform the above-described functions associated with the disclosed concepts. Each of these embodiments and obvious variations thereof are contemplated as falling within the spirit and scope of the following claims. Moreover, the present concepts expressly include any and all combinations and sub-combinations of the preceding elements and aspects.

What is claimed is:

1. A computer-implemented method of managing gifting in a wagering game, comprising:
determining a transfer of a gift value from a first player account to a second player account;
determining a wager of the gift value from the second player account in the wagering game;
determining a gift win amount attributable to a winning outcome of the wagering game when the gift value is used;
determining a first player portion of the gift win amount; and
determining a second player portion of the gift win amount.

2. The computer-implemented method of claim 1, in which the method further comprises configuring the wagering game to have a first payout table and a second payout table having a higher expected value than the first payout table, and in which the gift win amount is based on the second payout table.

3. The computer-implemented method of claim 1, in which the gift value comprises a gift currency, and in which determining the transfer of the gift value from the first player account to the second player account is configured to validate the gift currency for use in the wagering game.

4. The computer-implemented method of claim 3, in which determining the wager of the gift value comprises determining when the gift currency is wagered in the wagering game.

5. The computer-implemented method of claim 3, further comprising crediting the gift value of gift currency to the first player account based on an achievement during play of a wagering game associated with the first player account.

6. The computer-implemented method of claim 3, further comprising crediting the gift value of gift currency to the first player account based on a deposit into the first player account.

7. The computer-implemented method of claim 3, in which determining the first player portion of the gift win amount comprises applying one of a new account percentage and an existing account percentage to the gift win amount, wherein the new account percentage is applied when the second player account comprises a new player account and the existing account percentage is applied when the second player account comprises an existing player account.

8. The computer-implemented method of claim 3, further comprising:
determining a first gift value amount and a second gift value amount, wherein the second gift value amount is greater than the first gift value amount; and
determining a first level percentage associated with the first gift value amount and a second level percentage associated with the second gift value amount, wherein the second level percentage is greater than the first level percentage;
wherein determining the first player portion of the gift win amount comprises applying the first level percentage when the gift value is equal to the first gift value amount and applying the second level percentage when the gift value is equal to the second gift value amount.

9. The computer-implemented method of claim 1, in which the first player portion of the gift win amount comprises all of the gift win amount.

10. The computer-implemented method of claim 9, further comprising:
determining a minimum gameplay threshold associated with the wagering game; and
determining whether the minimum gameplay threshold is met before proceeding to determining the gift win amount.

11. The computer-implemented method of claim 1, further comprising crediting the first player account with the first player portion of the gift win amount and the second player account with the second player portion of the gift win amount.

12. The computer-implemented method of claim 1, in which the transfer of the gift value comprises crediting the gift value to a gifted balance associated with the second player account, the gifted balance including a gift play setting configured to allow access to the gift value when activated, and in which determining the wager of the gift value comprises determining whether the gift play setting is activated.

13. A gaming system comprising a processor, a memory, in communication with the processor, a display, and an input/output circuit, the processor being physically configured according to computer executable instructions for managing gifting in a wagering game, the computer executable instructions comprising instructions for:
determining a transfer of a gift value from a first player account to a second player account;
determining a wager of the gift value from the second player account in the wagering game;
determining a gift win amount attributable to an outcome of the wagering game when the gift value is used;
determining a first player portion of the gift win amount; and
determining a second player portion of the gift win amount.

14. The gaming system of claim 13, in which the gift value comprises a gift currency, and in which determining the transfer of the gift value from the first player account to the second player account is configured to validate the gift currency for use in the wagering game.

15. The gaming system of claim 14, in which determining the first player portion of the gift win amount comprises applying one of a new account percentage and an existing account percentage to the gift win amount, wherein the new account percentage is applied when the second player account comprises a new player account and the existing account percentage is applied when the second player account comprises an existing player account.

16. The gaming system of claim 13, in which the transfer of the gift value comprises crediting the gift value to a gifted balance associated with the second player account, the gifted balance including a gift play setting configured to allow access to the gift value when activated, and in which determining the wager of the gift value comprises determining whether the gift play setting is activated.

17. A tangible machine-readable storage media including instructions which, when executed by one or more processors, cause the one or more processors to perform operations comprising:
determining a transfer of a gift value from a first player account to a second player account;
determining a wager of the gift value from the second player account in the wagering game;
determining a gift win amount attributable to an outcome of the wagering game when the gift value is used;
determining a first player portion of the gift win amount; and
determining a second player portion of the gift win amount.

18. The tangible machine-readable storage media of claim 17, in which the gift value comprises a gift currency, and in which determining the transfer of the gift value from the first player account to the second player account is configured to validate the gift currency for use in the wagering game.

19. The tangible machine-readable storage media of claim 18, in which determining the first player portion of the gift win amount comprises applying one of a new account percentage and an existing account percentage to the gift win amount, wherein the new account percentage is applied when the second player account comprises a new player account and the existing account percentage is applied when the second player account comprises an existing player account.

20. The tangible machine-readable storage media of claim 17, in which the transfer of the gift value comprises crediting the gift value to a gifted balance associated with the second player account, the gifted balance including a gift play setting configured to allow access to the gift value when activated, and in which determining the wager of the gift value comprises determining whether the gift play setting is activated.
